(19) United States
(12) Patent Application Publication
(10) Pub. No.: US 2011/0090957 A1
(43) Pub. Date: Apr. 21, 2011

(54) VIDEO CODEC METHOD, VIDEO ENCODING DEVICE AND VIDEO DECODING DEVICE USING THE SAME

(75) Inventors: CHIA-WEI LIAO, Tu-Cheng (TW); YA-TING YANG, Tu-Cheng (TW); YI-SHIN TUNG, Tu-Cheng (TW)

(73) Assignee: HON HAI PRECISION INDUSTRY CO., LTD., Tu-Cheng (TW)

(21) Appl. No.: 12/650,760

(22) Filed: Dec. 31, 2009

(30) Foreign Application Priority Data
Oct. 20, 2009 (CN) 200910308476.0

(51) Int. Cl. H04N 7/26

(52) U.S. Cl. 375/240.12; 375/E07.243; 370/229

(57) ABSTRACT

A video codec method synchronizes long term reference frames in a video encoding device and a video decoding device of a video communication system. The video encoding device encodes video frames to code streams in an inter-prediction mode and set the corresponding reference frames to non-committed long term reference frames. The video decoding device decodes the code streams using the corresponding reference frames, then transmits an acknowledgement of the non-committed long term reference frames to the video encoding device. The video encoding device sets the non-committed long term reference frames to committed long term reference frames, and encodes succeeding video frames in the inter-prediction mode using the committed long term reference frames.

### BACKGROUND

1. Technical Field

Embodiments of the present disclosure relate to video codec technologies, and particularly to a video codec method used in a video communication system, and a video encoding device and a video decoding device using the same.

2. Description of Related Art

Video compression standard H.264, also known as MPEG-4 Part 10/AVC for advanced video coding, has become popular for video conferencing, video surveillance, video telephones and other applications. In the H.264 standard, video frames are encoded and decoded in an inter- or intra-prediction mode. Depending on the mode, different types of frames such as I-frames, P-frames and B-frames, may be used in the video communication. Specifically, the I-frames are encoded in the intra-prediction mode and can be independently decoded without reference to other frames. The P-frames and B-frames are encoded in the inter-prediction mode using reference frames and also require decoding using the same reference frames.

However, there are inevitable bandwidth fluctuations in an electronic communication network, which often cause data packet loss. During the video communications, the data packet loss may lead to reference frame loss in a decoding device. Therefore, some B-frames and P-frames cannot be decoded using the correct reference frames, and quality of the video communications correspondingly degrades.

### BRIEF DESCRIPTION OF THE DRAWINGS

Many aspects of the embodiments can be better understood with references to the following drawings, wherein like numerals depict like parts, and wherein:

FIG. 1 shows an application environment of a video communication system;

FIG. 2 shows detailed blocks of a disclosed video encoding device of FIG. 1;

FIG. 3 shows detailed blocks of a disclosed video decoding device of FIG. 1; and

FIG. 4 and FIG. 5 are flowcharts of a video codec method of one embodiment of the present disclosure.

### DETAILED DESCRIPTION

### Application Environment

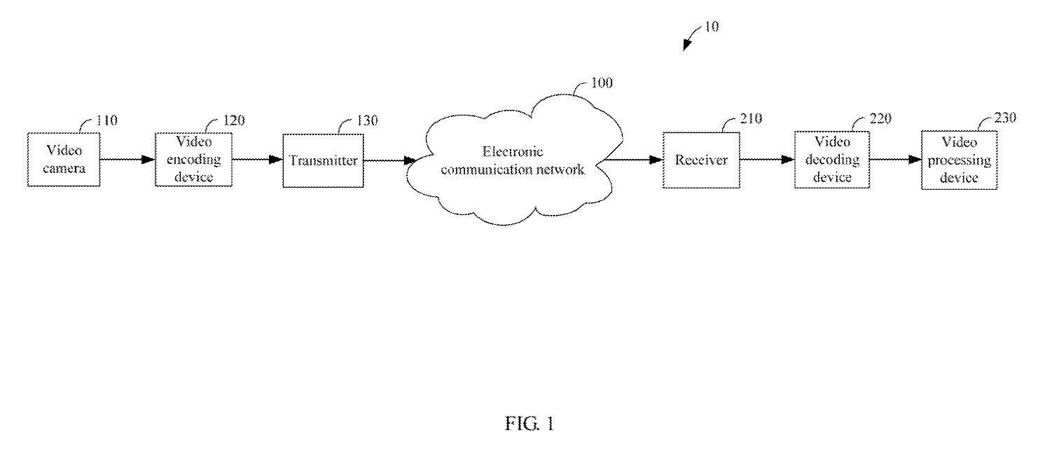

Referring to FIG. 1, an exemplary application environment of a video communication system 10 is shown. The video communication system 10 comprises a video camera 110, a video encoding device 120 as disclosed, a transmitter 130, a receiver 210, a video decoding device 220 as disclosed, and a video processing device 230. In the embodiment, the video camera 110, the video encoding device 120 and the transmitter 130 are in one location, and the receiver 210, the video decoding device 220 and the video processing device 230 are preferably in another location, intercommunicating by way of an electronic communication network 100 for long distance communications, such as video conferencing and video surveillance.

In this embodiment, the video camera 110 records images in the first location to generate video frames. The video encoding device 120 encodes the video frames output by the video camera 110 to generate corresponding code streams. The transmitter 130 transmits the code streams of the video frames to the receiver 210 in the form of data packets via the electronic communication network 100. The receiver 210 recovers the data packets to the code streams, and outputs the code streams to the video decoding device 220. The video decoding device 220 decodes the code streams to obtain the corresponding video frames, and transmits the video frames to the video processing device 23 for display, storage or transmission. In this embodiment, both the video encoding device 120 and the video decoding device 220 operate in accordance with video compression standard H.264.

Structure of Video Encoding Device

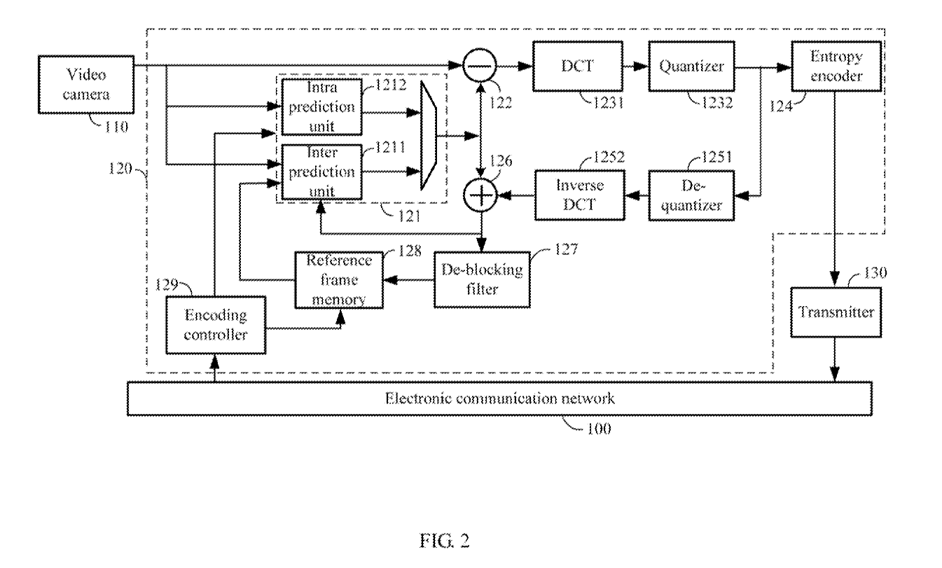

Referring to FIG. 2, a detailed block diagram of the video encoding device 120 in FIG. 1 is shown. In this embodiment, the video encoding device 120 comprises a prediction encoder 121, a subtracter 122, a discrete cosine transformer (DCT) 1231 and a quantizer 1232, an entropy encoder 124, a de-quantizer 1251 and an inverse DCT 1252, an adder 126, a de-blocking filter 127, a reference frame memory 128 and an encoding controller 129. The prediction encoder 121 comprises an inter-prediction unit 1211 to perform inter-predictions to generate prediction frames of the video frames in an inter-prediction mode, and an intra-prediction unit 1212 to perform intra-predictions to generate the prediction frames of the video frames in an intra-prediction mode. The DCT 1231 performs discrete cosine transform, and the quantizer 1232 performs quantization. The de-quantizer 1251 performs de-quantization, and the inverse DCT 1252 performs inverse discrete cosine transforms.

Structure of Video Decoding Device

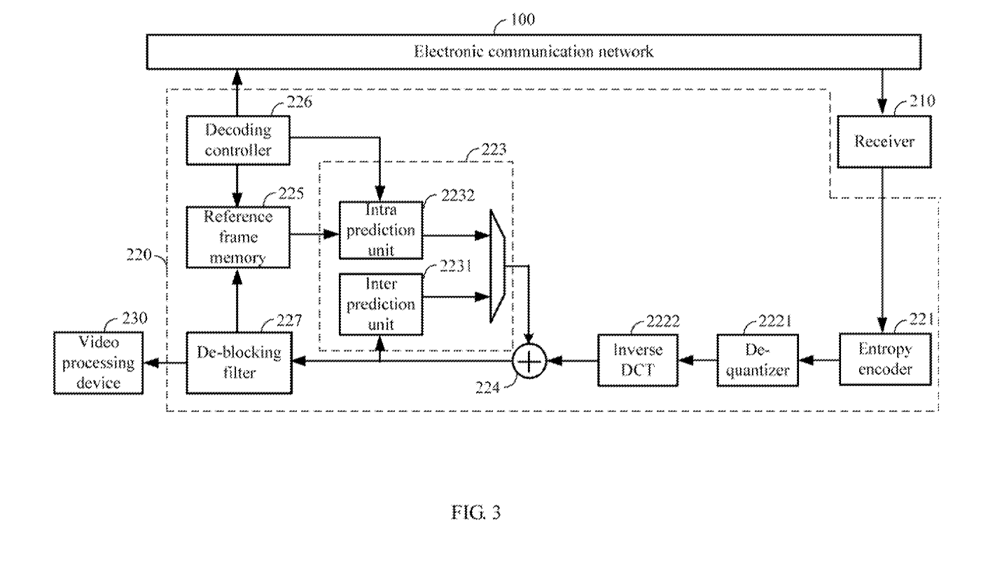

Referring to FIG. 3, a detailed block diagram of a video decoding device 220 in FIG. 1 is shown. The video decoding device 220 comprises an entropy decoder 221, a de-quantizer 2221 and an inverse DCT 2222, a prediction decoder 223, an adder 224, a reference frame memory 225, a decoding controller 226 and a de-blocking filter 227. The de-quantizer 2221 and the inverse DCT 2222 operate in the same way as the de-quantizer 1251 and inverse DCT 1252. The prediction decoder 223 comprises an inter-prediction unit 2231 to perform the inter-predictions to generate the prediction frames of the video frames in the inter-prediction mode, and an intra-prediction unit 2232 to perform the intra-predictions to generate the prediction frames of the video frames in the intra-prediction mode.

Operations of Video Encoding Device and Video Decoding Device

In this embodiment, the prediction encoder 121 generates the prediction frames of the sequent video frames output by the video camera 110 in the inter-prediction mode and the intra-prediction mode. In the H.264 standard, a first one of the sequent video frames is always encoded in the intra-prediction mode, and succeeding video frames are encoded in the inter-prediction mode or the intra predication mode according to predetermined regulations. In this embodiment, when the electronic network communication 100 is uncongested (e.g, communication on the video communication system 10 is normal), the video encoding device 120 encodes the succeeding video frames in the intra-prediction mode once in each period, such as 1 second, according to practical requirements. In alternative embodiments, the video encoding device 120 chooses the inter-prediction mode or the intra-prediction mode according to contents of the video frames. For example, if a current video frame differs greatly from the preceding video frames, the video encoding device 120 encodes the current video frame in the intra-prediction mode.

The subtracter 122 compares the video frames with the corresponding prediction frames output by the prediction encoder 121 to generate corresponding residual differences. The entropy encoder 125 encodes the transformed and quantized residual difference output by the DCT 1231 and the quantizer 1232 to generate the code streams of the video frames. In compliance with the H.264 standard, the code stream corresponding to each video frame comprises a header to store encode information required by the decoding of the video frame, such as the prediction mode, indexes of the reference frames, coefficients of the entropy encoding and the DCT and quantization. Subsequently, the code streams of the video frames are transmitted to the video decoding device by the transmitter 130 and the receiver 210 in form of data packets via the electronic communication network 100.

The transformed and quantized residual difference is further output to the de-quantizer 1251 and the inverse DCT 1252 to be de-quantized and inverse discrete cosine transformed to obtain reconstructed residual difference. The adder 125 adds the reconstructed residual difference and the corresponding prediction frames output by the prediction encoder 121 so as to generate the reconstructed video frames. The de-blocking filter 127 eliminates artifact blocking of the reconstructed video frames to generate better visual video frames. The better visual video frames are output to the reference frame memory 128 as new reference frames. The new reference frames are available for the succeeding video frames that have been encoded in the inter-prediction mode.

The reference frame memory 128 stores the reference frames of multiple types. In the H.264 standard, the reference frames comprise long term reference frames and short term reference frames. Both the long term reference frames and the short term reference frames have individual indexes for identification. The long term reference frames and the short term reference frames update in different ways. Specifically, the short term reference frames update automatically in a first-in first-out (FIFO) manner when the video frames are being encoded. The long term reference frames update according to particular orders of the video encoding device 120. In the embodiment, the long term reference frames are further divided into non-committed long term reference frames and committed long term reference frames. It is noted that the non-committed and committed long term reference frames are sorted according to whether the long term reference frames are acknowledged by both the video encoding device 120 and the video decoding device 220. For example, if the video encoding device 120 encodes a video frame to a code stream in the inter-prediction mode, the corresponding reference frames in the reference frame memory 128 are set as the non-committed long term reference frames. Correspondingly, if the video decoding device 220 is operable to decode the code stream correctly, the corresponding reference frames in the reference frame memory 225 are set as the non-committed long term reference frames. Subsequently, the video decoding device 220 transmits an acknowledgement of the non-committed long term frames to the encoding device 120. In response to the acknowledgement, the non-committed long term reference frames in the encoding device 120 are set as the committed long term reference frames. In the embodiment, both the non-committed long term reference frames and the committed long term reference frames are identified by their indexes.

The encoding controller 129 detects the communication on the electronic communication network 100 and receives the acknowledgement of the non-committed long term reference frames transmitted by the video decoding device 220. Accordingly, the encoding controller 129 controls the prediction modes of the video frames and the types of the corresponding reference frames. In the embodiment, when the communication is uncongested, the encoding controller 129 controls the video encoding device 120 to encode the video frames according to the predetermined regulations as mentioned. When communication is congested, the encoding controller 129 directs the video encoding device 120 to encode the current video frame to the code stream in the inter-prediction mode, and sets the corresponding reference frames used in the inter-prediction of the current video frame as the non-committed long term reference frames.

The receiver 210 receives and recovers the data packets of the code streams transmitted via the electronic communication network 100 to the code streams of the video frames, and outputs the code streams of the video frames to the video decoding device 220.

The video decoding device 220 analyzes the code streams of the video frames to obtain the encoding information, such as the prediction modes, the reference frame indexes, the entropy encoding coefficients, and the DCT and quantization coefficients, for example. Correspondingly, the video decoding device 220 determines the prediction modes of the code streams of the video frames and the types of the corresponding reference frames.

In the embodiment, the entropy decoder 221 decodes the code streams of the video frames according to the entropy encoding coefficients. The de-quantizer 2221 and the inverse DCT 2222 perform the de-quantization and the inverse discrete cosine transformation according to the quantization and DCT coefficients, and generates the reconstructed residual difference. In the H.264 standard, the reconstructed residual difference generated by the de-quantizer 2221 and the inverse DCT 2222 is similar to that generated by the de-quantizer 1251 and the inverse DCT 1252 because of lossless compression features of the entropy codec. The prediction decoder 223 generates the prediction frames corresponding to the reconstructed residual difference in the inter-prediction mode or the intra-prediction mode according to the prediction modes of the code streams of the video frames. For example, if the code streams of the video frames are encoded in the intra-prediction mode without reference to other frames by the video encoding device 120, the prediction decoder 223 generates the prediction frames of the video frames in the intra-prediction mode without reference to other frames. If the code streams of the video frames are encoded in the inter-prediction mode using the reference frames by the video encoding device 120, the prediction decoder 223 finds the corresponding reference frames in the reference frame memory 225, and generates the prediction frames of the video frames using the corresponding reference frames. The adder 224 adds the corresponding prediction frames output by the prediction decoder 223 and the corresponding reconstructed residual difference to generate the reconstructed video frames. The de-blocking filter 227 filters the reconstructed video frames to eliminate the artifact blocking thereof, and provides the better visual video frames to the video processing device 230. The better visual video frames are further output to the reference frame memory 128 as the new reference frames. The new reference frames are available for the decoding of the code streams of the succeeding video frames.

During decoding of a code stream of a current video frame encoded in the inter-prediction mode using the long term reference frames, if the video decoding device 220 is operable to find the corresponding reference frames in the reference frame memory 225, the code stream of the current video frame has been correctly decoded. In addition, the corresponding reference frames in the reference frame memory 225 are set to the non-committed long term reference frames, and the decoding controller 226 transmits the acknowledgment of the non-committed long term reference frames to the encoding controller 129 of the video encoding device 120. If the video decoding device 220 cannot find the corresponding reference frames in the reference frame memory 225, decoding of the code stream of the current video frame ends. In alternative embodiments, the decoding controller 226 may further transmits a non-acknowledgment of the non-committed long term reference frames to the encoding controller 129 of the video encoding device 120.

The encoding controller 129 of the video encoding device 120 receives the acknowledgement transmitted by the decoding controller 226 of the video decoding device 220, and the corresponding non-committed long term reference frames in reference frame memory 128 are set as the committed long term reference frames. The encoding controller 129 further directs the video encoding device 120 to encode a next video frame to the code stream in the inter-prediction mode using the committed long term reference frames. Subsequently, the code stream of the next video frame is transmitted to the video decoding device 220 via the electronic communication network 100 by the transmitter 130 and the receiver 210.

In the embodiment, if the encoding controller 129 of the video encoding device 120 does not receive the acknowledgment of the non-committed long term reference frames in a predetermined time, the video decoding device 220 cannot find the corresponding reference frames of the code stream of the current frame in the reference memory 225. In alternative embodiments, the encoding controller 129 of the video encoding device 120 may receive the non-acknowledgment of the non-committed long term reference frames. The video encoding devices 120 encodes the current video frame to the code stream using other reference frames. Correspondingly, the other reference frames are set as the non-committed long term reference frames. The code stream of the current video frame is re-transmitted to the video decoding device 220. The video decoding device 220 decodes the code stream of the current video frame again as described.

In the embodiment, when the code stream of the next video frame is transmitted to the video decoding device 220, the video decoding device 220 analyzes the code stream of the next video frame to obtain the encoding information. If the reference frame used in the encoding of the next video frame is corresponding to the non-committed long term reference frames in the reference frame memory 225, then the non-committed long term reference frames in the reference frame memory 225 are set to the committed long term reference frames. Subsequently, the video decoding device 220 decodes the next video frame in the inter-prediction mode using the committed long term reference frames. If, however, the code stream of the next video frame is encoded in the intra-prediction mode or the inter-prediction mode using the short term reference frames, the decoding controller 226 directs the prediction decoder 223 to encode the next video frame normally, that is in the intra-prediction mode or the inter-prediction mode using the short term reference frames correspondingly.

The encoding controller 129 of the video encoding device 120 continuously detects the communication on the video communication system 10. If communication is congested, the video encoding device 120 encodes the succeeding video frames in the inter-prediction mode using the committed long term reference frames. If the communication is uncongested, the video encoding device 120 encodes the succeeding video frames according to the predetermined regulation as described.

Video Codec Method

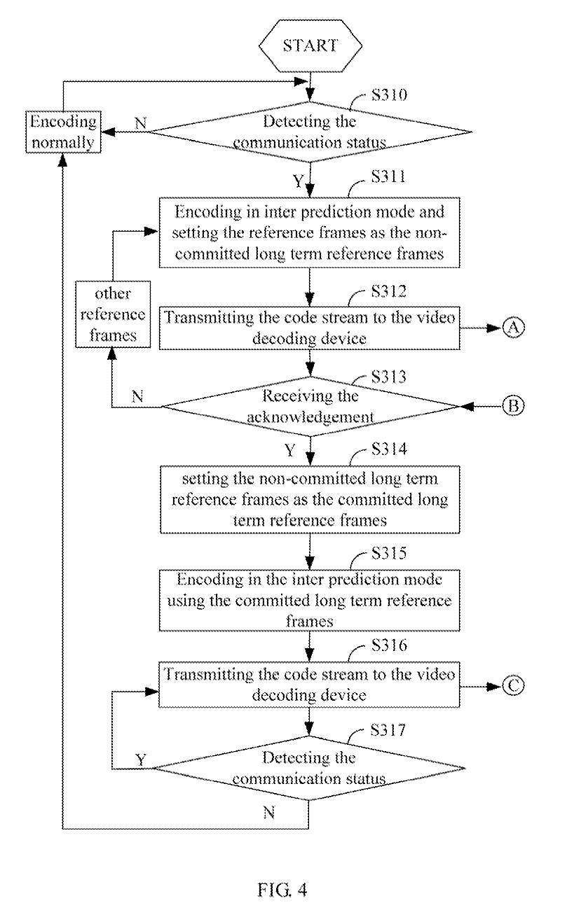

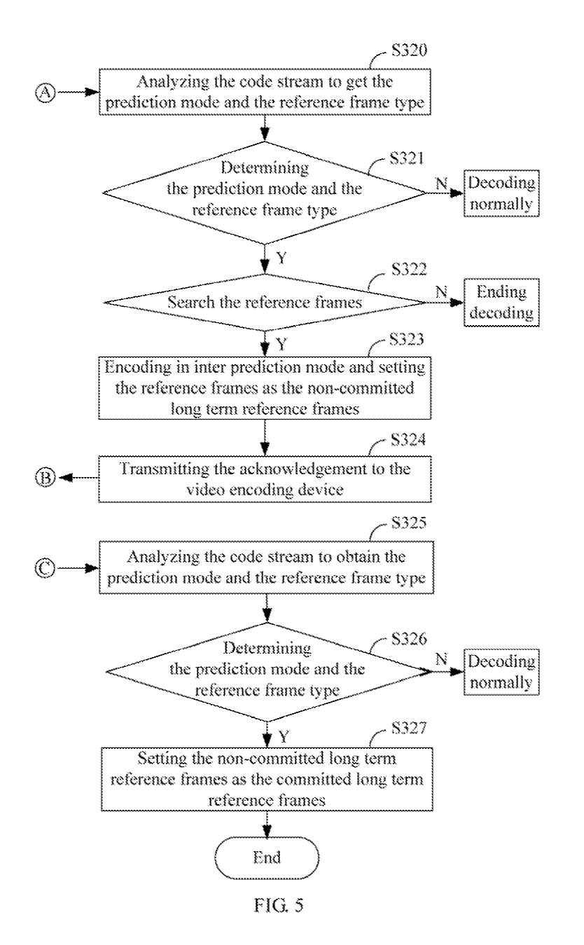

Referring to FIG. 4 and FIG. 5, flowcharts of a video codec method are shown. The video codec method is applicable, for example, for the video communication system 10 and comprises a plurality of steps as follows.

In step S310, the encoding controller 129 detects the communication on the video communication system 10, and sets the prediction modes of the video frames and the types of the corresponding reference frames used in the inter-prediction accordingly. If the communication is uncongested, the video encoding device 120 encodes the current video frame to the code stream according to the predetermined regulation as described.

In step S311, if communication is congested, the video encoding device 120 encodes the current video frame to the code stream in the inter-prediction mode, and the corresponding reference frames used in the inter-prediction are set as the non-committed long term reference frames.

In step S312, the code stream of the current video frame is transmitted to the video decoding device 220 in the form of data packets via the electronic communication network 100 by the transmitter 130 and the receiver 210.

In step S320, the video decoding device 220 analyzes the code stream of the current video frame to acquire the encoding information, such as the prediction modes, the reference frame indexes, for example but not limited.

In step S321, the video decoding device 220 determines the prediction modes of the current video frame and the types of corresponding reference frames, and decodes the code stream of the current video frame accordingly. If the current video frame is not encoded in the inter-prediction mode or the corresponding reference frames used in the inter-prediction of the current video frame are not the long term reference frames, the video decoding device 220 decodes the code stream of the current video frame in the intra-prediction mode or the inter-prediction mode using the short term reference frames correspondingly.

In step S322, if the current video frame is encoded in the inter-prediction mode and the corresponding reference frames used in the inter-prediction of the current video frame are the long term reference frames, the video decoding device 220 searches the corresponding reference frames in the reference frame memory 225 to decode the code stream of the current video frame. If the video decoding device 220 cannot find the corresponding reference frames in the reference frame memory 225, then decoding of the code stream of the current video frame ends. In alternative embodiments, the decoding controller 226 may further transmit the non-acknowledgement of the non-committed long term reference frames to the video encoding device 120.

In step S323, if the video decoding device 220 finds the corresponding reference frames in the reference frame 225, the video decoding device 220 decodes the code stream of the current video frame correctly. Correspondingly, the corresponding reference frames are set as the non-committed long term reference frames.

In step S324, the video decoding device 220 transmits an acknowledgement of the non-committed long term reference frames to the encoding controller 129 of the video encoding device 120 via the electronic communication network 10.

In step S313, the encoding controller 129 of the video encoding device 120 determines whether the video decoding device 220 receives the non-committed long term reference frames according to the acknowledgement. If the encoding controller 129 of the video encoding device 120 does not receive the acknowledgement in the predetermined time, the video encoding device 120 encodes the current video frame to the code stream in the inter-prediction mode using other reference frames. Correspondingly, the other reference frames are set as the non-committed long term reference frames. The code stream of the current video frame is transmitted to the video decoding device 220 again as set forth in the step S311.

In step S314, if the encoding controller 129 of the video encoding device 120 receives the acknowledgement in the predetermined time, the non-committed long term reference frames in the video encoding device 120 are set as the committed long term reference frames.

In step S315, the video encoding device 120 encodes a next video frame to the code stream in the inter-prediction mode using the committed long term reference frames.

In step S316, the code stream of the next video frame is transmitted to the video decoding device 220 in the form of data packets via the electronic communication network 100 by the transmitter 130 and the receiver 210.

In step S325, the video decoding device 220 analyzes the code stream of the next video frame to obtain the encoding information required for decoding the code stream of the next video frame.

In step S326, the video decoding device 220 decodes the code stream of the next video frame according to the prediction mode and the reference frame type thereof. If the next video frame is not encoded in the inter-prediction mode or the reference frames used in the inter-prediction of the subsequent video frame are not the long term reference frames, the video decoding device 220 decodes the code stream of the subsequent video frame in the intra prediction mode or in the inter prediction mode using the short reference frames correspondingly.

In step S327, if the next video frame is encoded in the inter-prediction mode and the reference frames used in the inter-prediction of the next video frame corresponding to the non-committed long term reference frames in the reference frame memory 225, the non-committed long term reference frames in the video decoding device 220 are set as the committed long term reference frames. Subsequently, the video decoding device 220 decodes the code stream of the next video frame in the inter-prediction mode using the non-committed long term reference frames in the reference frame memory 225.

In step S317, the encoding controller 129 detects the communication on the electronic communication network 100, and sets the prediction modes of the video frames and the types of the corresponding reference frame. If communication is congested, the video encoding device 120 encodes the succeeding video frames in the inter-prediction mode using the committed long term reference frames as the step S315. If the communication is uncongested, the video encoding device 120 encodes the succeeding video frames according to the predetermined regulations.

It is apparent that embodiments of the present disclosure provides a video codec method, a video encoding device and a video decoding device using the same operable to encode and decode the video frames using the non-committed and committed long term reference frames when communication is congested. Accordingly, the long term reference frames of the encoding device and the decoding device utilized in the video frames are synchronous. As a result, decode errors caused by the reference frames losses when the data packets losses occur in the communication congestion are eliminated, and the image quality of the video communication system improves considerably.

It is believed that the present embodiments and their advantages will be understood from the foregoing description, and it will be apparent that various modifications, alternations and changes may be made thereto without departing from the spirit and scope of the present disclosure, the examples hereinbefore described merely being preferred or exemplary embodiments of the present disclosure.

What is claimed is:

1. A video encoding device to communicate with a video decoding device, the video encoding device comprising:
a reference frame memory to store reconstructed video frames as reference frames, wherein the reference frames comprises non-committed long term reference frames and committed long term reference frames, the non-committed long term reference frames and the committed long term reference frames sorted according to whether the reference frames are acknowledged by both the video encoding device and the video decoding device;
an encoding controller to set prediction modes of the video frames and types of the corresponding reference frames according an acknowledgement of the non-committed long term reference frames transmitted from the video decoding device;
wherein when the video encoding device encodes the video frames in an inter-prediction mode using long term reference frames, the corresponding reference frames are set as the non-committed long term reference frames;
wherein, if acknowledgement of the non-committed long term reference frames is received from the video decoding device, the non-committed long term reference frames are set as the committed long term reference frames, and the video encoding device encodes succeeding video frames in the inter-prediction mode using the committed long term reference frames.

2. The video encoding device as claimed in claim 1, wherein code streams of the video frames are transmitted to the video decoding device via an electronic communication network.

3. The video encoding device as claimed in claim 1, wherein the encoding controller directs the video encoding device to encode the video frames to the code streams in the inter-prediction mode using the long term reference frames if communication on the electronic communication network is congested.

4. The video encoding device as claimed in claim 1, wherein the acknowledgement of the non-committed long term reference frames is transmitted to the video encoding device via the electronic communication network.

5. The video encoding device as claimed in claim 1, wherein the encoding controller further detects the communication on the electronic communication network.

6. A video decoding device to communicate with a video encoding device, the video decoding device comprising:
a reference frame memory to store reconstructed video frames as reference frames comprising non-committed long term reference frames and committed long term reference frames, the non-committed long term reference frames and committed long term reference frames sorted according to whether the reference frames are acknowledged by both the video decoding device and the video encoding device; and
a decoding controller to set the types of reference frames and transmit an acknowledgement of the non-committed long term reference frames to the video encoding device;
wherein if code streams received by the video decoding device are encoded in an inter-prediction mode using long term reference frames by the video encoding device, the corresponding reference frames used in the decoding are set as the non-committed long term reference frames, and the acknowledgement of the non-committed long term reference frames is transmitted to the video encoding device;
if the reference frames of the code streams received correspond to the non-committed long term reference frames in the video decoding device, the non-committed long term reference frames are set as the committed long term reference frames, and the code streams are decoded using the committed long term reference frames.

7. The video decoding device as claimed in claim 6, wherein the code streams are transmitted by the video encoding device via an electronic communication network.

8. The video decoding device as claimed in claim 6, wherein the video decoding device transmits the acknowledgement of the non-committed long term reference frames to the video encoding device via the electronic communication network.

9. A video codec method used in a video communication system comprising a video encoding device and a video decoding device, the video codec method comprising:
detecting communication on the video communication system and setting prediction modes of the video frames and types of corresponding reference frames;
encoding a current video frame to a code stream in an inter-prediction mode and setting the corresponding reference frames in the video encoding device as the non-committed long term reference frames;
decoding the code stream of the current video frame and setting the corresponding reference frames in the video decoding device as the non-committed long term reference frames;
transmitting an acknowledgement of the non-committed long term reference frames to the video encoding device;
setting the non-committed long term reference frames in the video encoding device as the committed long term reference frames according the acknowledgement and encoding a next video frame to the code stream in the inter-prediction mode using the committed long term reference frames;
setting the non-committed long term reference frames in the video decoding device as the committed long term reference frames and decoding the code stream of the next video frame using the committed long term reference frames; and
detecting the communication continuously and encoding succeeding video frames to the code streams in the inter-prediction mode using the committed long term reference frames in the video encoding device before the communication is uncongested.

10. The video codec method as claimed in claim 9, further comprising transmitting the code streams of the video frames from the video encoding device to the video decoding device via an electronic communication network.

11. The video codec method as claimed in claim 9, further comprising transmitting the acknowledgement of the non-committed long term reference frames from the video decoding device to the video encoding device via the electronic communication network.

12. The video codec method as claimed in claim 9, further comprising encoding the video frames normally if the communication is uncongested.

13. The video codec method as claimed in claim 9, further comprising ending the decoding of the code stream of the current video frame if no corresponding reference frames are found in the video decoding device.

14. The video codec method as claimed in claim 13, further comprising, if the video decoding device does not receive the acknowledgement in a predetermined time, encoding the current video frame to the code stream in the inter-prediction mode using other reference frames and setting the other reference frames to the non-committed long term reference frames.

15. The video codec method as claimed in claim 13, further comprising transmitting a non-acknowledgement of the non-committed long term reference frames to the video encoding device.

16. The video codec method as claimed in claim 15, further comprising encoding the current video frame to the code stream in the inter-prediction mode using other reference frames and setting the other reference frames to the non-committed long term reference frames if the video decoding device receives the non-acknowledgement.
